(19) United States
(12) Patent Application Publication
(10) Pub. No.: US 2006/0273882 A1
(43) Pub. Date: Dec. 7, 2006

(54) RFID tag with separate transmit and receive clocks and related method

(75) Inventor: Joshua Posamentier, Oakland, CA (US)

Correspondence Address: THE LAW OFFICES OF JOHN C. SCOTT, LLC;C/O INTELLEVELE, P. O. BOX 52050, MINNEAPOLIS, MN, 55402, US

(73) Assignee: Intel Corporation

(21) Appl. No.: 11/142,424

(22) Filed: Jun. 1, 2005

(51) Int. Cl. H04Q 5/22

(52) U.S. Cl. 340/10.4; 340/10.3

(57) ABSTRACT

An RFID tag includes separate transmit and receive clocks. In at least one embodiment, the transmit clock frequency is adjusted based on an amount of power available to transmit a response signal to a reader.

### TECHNICAL FIELD

The invention relates generally to wireless systems and, more particularly, to radio frequency identification (RFID) structures and techniques.

### BACKGROUND OF THE INVENTION

An RFID tag is a radio frequency (RF) transponder device that is designed to respond to the receipt of an interrogation signal from an RFID reader device by communicating information back to the reader device. RFID tags are currently used in a wide variety of applications including, for example, pallet tracking, inventory tracking, airport baggage tracking, tracking of pets, item identification, personnel identification (e.g., ID badges), and many others. RFID tags typically fall into two categories; namely, passive tags and active tags. An active RFID tag includes a power source (e.g., a battery, etc.) to power the circuitry therein. A passive RFID tag, on the other hand, does not include a power source. Instead, the passive RFID tag derives its operation power from the interrogation signal received from the reader device. The energy harnessed from the interrogation signal is temporarily stored within the passive tag and used to process the interrogation signal. In response to the interrogation, the tag then modulates and reflects the incoming carrier in order to communicate a response signal back to the reader. Because the RFID tag is powered solely by the interrogation signal, the maximum distance is limited by the actual power consumption of the RFID tag.

As is well known, the power density of an RF signal typically decreases as the signal propagates in space (due to spreading and environmental absorption). For this reason, as the distance between a reader device and an RFID tag increases, the signal strength of the interrogation signal upon reception in the tag will decrease. Eventually, a distance will be reached where it is no longer possible for the tag to power on because there is not enough energy available and hence the tag will be unable to respond to the interrogation. Techniques and structures are desired that are capable of increasing the read range between a reader device and an RFID tag.

### BRIEF DESCRIPTION OF THE DRAWINGS

FIG. 1 is a diagram illustrating an arrangement that may be used for reading an RFID tag in accordance with an embodiment of the present invention;

FIG. 2 is a timing diagram illustrating an exemplary interrogation signal waveform in accordance with an embodiment of the present invention;

FIG. 3 is a diagram illustrating an exemplary passive RFID tag architecture in accordance with an embodiment of the present invention; and

FIG. 4 is a flowchart illustrating an exemplary method for use in operating a passive RFID tag in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

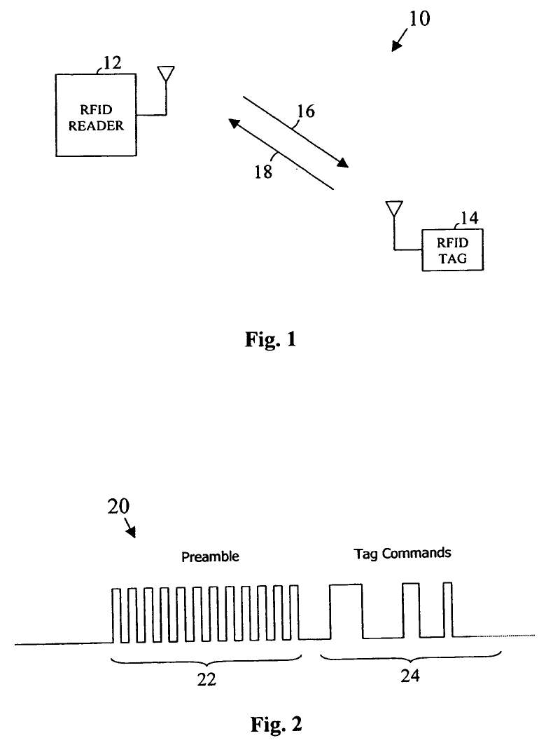

FIG. 1 is a diagram illustrating an arrangement 10 that may be used for reading an RFID tag in accordance with an embodiment of the present invention. When an RFID reader device 12 (or a user thereof) wishes to retrieve information from an RFID tag 14, the reader 12 first transmits a wireless interrogation signal 16 to the RFID tag 14. If within range of the reader 12, the RFID tag 14 causes information to be communicated back to the reader 12 in a wireless response signal 18. As will be discussed in greater detail, the wireless response signal 18 may be a signal actually transmitted from an antenna of the RFID tag 14 or a portion of the interrogation signal that is reflected from the antenna of the tag 14 and modulated by antenna impedance modulation. The wireless response signal 18 will typically include some information of interest to the reader 12. For example, the response signal 18 may include information identifying a product on which the RFID tag 14 is affixed (e.g., an electronic product code™ or EPC, etc.). In another application, the response signal 18 may include information identifying the contents of a container on which the tag 14 is affixed. Many other applications also exist. In some applications, the interrogation signal 16 may include one or more commands to be carried out by the RFID tag 14 (e.g., a command to retrieve only a certain type of information, etc.). After the command(s) have been executed within the RFID tag, the result of the command execution may be included in the response signal. In other applications, the interrogation signal 16 may include an ID number or address associated with the RFID tag 14. In such cases, the tag 14 may only respond to the interrogation signal if it detects its ID number within the signal. This technique may be used to locate a particular item within, for example, a warehouse or other large storage area (e.g., a library, etc.). As will be appreciated, the actual type of information that is included within an interrogation signal or a response signal in an RFID system will typically depend on the RFID application being implemented.

The RFID tag 14 of FIG. 1 is a passive tag. That is, the RFID tag 14 does not include its own power source. Instead, the tag derives power from the interrogation signal 16 received from the reader 12. Up to a particular range, the interrogation signal 16 will be capable of imparting enough stored energy to the tag 14 to allow the tag to cause the entire response signal to be communicated to the reader. Beyond that range, however, there may not be enough energy to perform this task. If there are objects between the reader and the RFID tag that are blocking the propagation of signals between the devices, then the effective range may become even smaller still. In accordance with aspects of the present invention, the transmit clock of the passive tag 14 is separated from the receive clock thereof and made variable in a manner that is capable of extending the read range of the tag 14. That is, during read operations where a relatively small amount of energy is available from the interrogation signal, the transmit clock may be set to a relatively low speed to conserve energy. During read operations where a relatively high amount of energy is available from the interrogation signal, the transmit clock may be set to a higher speed. Other intermediate clock speeds, or a continuously varying clock speed, may also be used.

FIG. 2 is a timing diagram illustrating an exemplary interrogation signal waveform 20 in accordance with an embodiment of the present invention. The waveform 20 uses a form of modulation known as amplitude shift keying (ASK) which involves changing the magnitude of the signal between two or more values to impart information to the signal. The waveform 20 represents the magnitude of the signal which actually rides on a radio frequency carrier (e.g., 900 MHz, etc.). In the illustrated embodiment, the waveform 20 changes between a fixed magnitude level and zero. ASK may also be implemented using three of more discrete magnitude levels. ASK modulation is one form of modulation that is often used within RFID systems because it is relatively simple and inexpensive to implement. Other modulation types may alternatively be used (e.g., phase shift keying (PSK), single side band (SSB), etc.). As shown in FIG. 2, the interrogation signal waveform 20 includes a preamble portion 22 and a command portion 24. The preamble portion 22 includes a known pattern that may be used by an RFID tag to synchronize a receive clock to the interrogation signal. The command portion 24 may include one or more commands to be carried out by the RFID tag. A continuous wave (CW) portion (not shown) may also be present for use in implementing backscatter antenna impedance modulation within the associated tag. As described above, the actual contents of an interrogation signal will typically depend upon the application being implemented and may be different from that shown in FIG. 2.

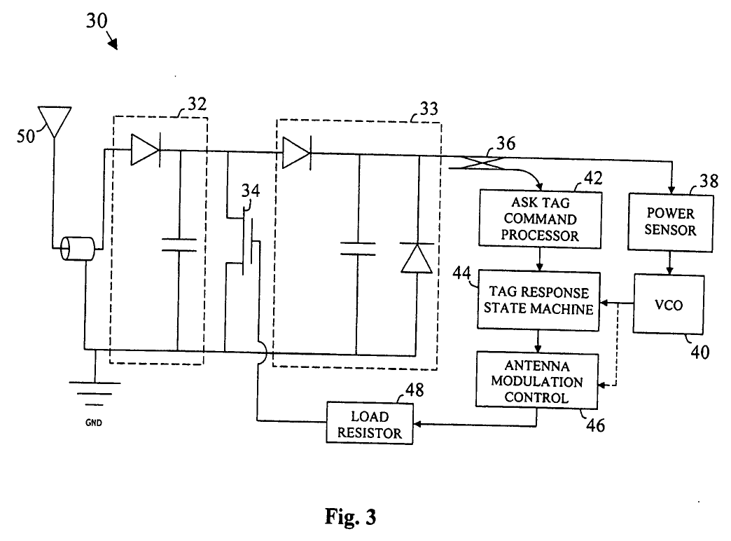

FIG. 3 is a diagram illustrating an example RFID tag architecture 30 in accordance with an embodiment of the present invention. The RFID tag architecture 30 may be used within, for example, the passive RFID tag 14 of FIG. 1 or other passive, semi-active, or fully active RFID tag devices. As shown, the RFID tag architecture 30 includes: first and second energy storage portions 32,33, an antenna modulation switch 34, a coupler 36, a power sensor 38, a VCO 40, an ASK tag command processor 42, a tag response state machine 44, an antenna modulation control unit 46, and a load resistor 48. An antenna 50 may be an integral part of the tag 30 or it may be coupled to the tag 30 after tag fabrication. A number of different antenna types may be used by the RFID tag 30, but low profile, inexpensive antenna types are preferred, such as microstrip dipoles, microstrip patches, microstrip helixes, element arrays, fractal antennas, patch antennas, and so on. During normal operation, an interrogation signal is transmitted to the RFID tag 30 and received by the antenna 50. The first and second energy storage portions 32, 33 are operative for storing energy from the interrogation signal for use as an energy source to power the circuitry within the tag 30. As shown, each storage portion 32, 33 may include, for example, rectification functionality (e.g., a diode or full wave rectification diode bridge, etc.) and one or more energy storage elements (e.g., a capacitor, an inductor, etc.). As will be described in greater detail, the antenna modulation switch 34 facilitates the performance of backscatter antenna impedance modulation for use in communicating the response signal back to the RFID reader.

The power sensor 38 is operative for measuring a power related parameter associated with the interrogation signal. The power related parameter may be any parameter that is related to an overall amount of energy that may be harnessed from the interrogation signal for use in powering the RFID tag 30. The output of the power sensor 38 is used to control the frequency of the VCO 40, which acts as the transmit clock of the RFID tag 30. The coupler 36 is operative for coupling a reduced amplitude version of the received interrogation signal to the ASK tag command processor 42 for processing. The ASK tag command processor 42 may first sense a preamble portion (e.g., preamble portion 22 of interrogation signal 20 of FIG. 2) of the interrogation signal and may receive recommended signal configuration information from the reader for operating parameters such as allowing fixed vs. variable clocks and acceptable modulation protocols. The ASK tag command processor 42 may then read and execute any commands within a command portion of the interrogation signal. The result of the command execution may be delivered to the tag response state machine 44 which generates the response data to be communicated back to the reader. Although illustrated as an ASK tag command processor 42, it should understood that different modulation schemes may alternatively be used in the RFID system and the processor 42 would be configured accordingly. As shown, in the illustrated embodiment, the tag response state machine 44 may receive the transmit clock output by the VCO 40 for use in generating the response data. The antenna modulation control unit 46 is operative for controlling the backscatter antenna impedance modulation process that is used to communicate the response signal to the reader. The antenna modulation control unit 46 may use the load resistor 48 and the antenna modulation switch 34 to carry out the modulation.

Backscatter antenna impedance modulation typically involves modulating the input impedance of an antenna (as seen from space) in a manner that imparts information to signal energy that is reflected from the antenna in backscatter fashion. As described previously, a portion of the interrogation signal that is transmitted to a tag may include CW energy. This energy may be either absorbed or reflected from the antenna 50 of the tag 30 when incident thereon. By varying (i.e., modulating) the impedance of the antenna, the portion of the incident CW energy that is reflected, rather than absorbed, can be varied. The antenna modulation switch 34 is used to modulate the impedance seen looking into the antenna 50 from free space. For example, if the switch 34 is turned fully “on,” the antenna 50 is shorted and thus reflects more incident energy. If the switch 34 is turned “off,” the antenna 50 is not shorted and thus absorbs more incident energy. The antenna modulation control 46 delivers a signal to the load resistor 48 that develops the control signal to be applied to the antenna modulation switch 34 to appropriately vary the impedance of the antenna. The resulting reflected energy is received and separated from the carrier by the reader which comprehends it as the response signal. Other techniques for implementing backscatter antenna impedance modulation may alternatively be used. In some embodiments, other types of modulation are used to communicate the response data to the reader. For example, phase reverse keying, amplitude shift keying, and/or others techniques may be used by the tag itself.

As described above, the power sensor 38 is operative for measuring a power related parameter associated with the interrogation signal. The power related parameter is some parameter that is indicative of the amount of energy that can be derived from the interrogation signal for use in powering the RFID tag 30. If the interrogation signal can provide a high amount of energy, then the power sensor 38 may cause the VCO 40 to generate a higher clock frequency. If the interrogation signal can only provide a small amount of energy (e.g., there is significant attenuation between the reader and the tag), then the power sensor 38 may cause the VCO 40 to generate a low clock frequency to conserve energy. By using a lower clock frequency, it is anticipated that the overall range of the RFID tag is increased by two factors: namely, (a) the superior signal to noise ratio (SNR) a lower frequency RFID tag response has and (b) the lower power consumption of the tag itself at extreme distances, where the RF power harvesting is near the limit of where a higher frequency RFID tag might operate. Many current RFID systems are forward link limited which means their maximum range is limited only by the tag's ability to harvest power from the RFID reader, rather than the reader's ability to receive the tag's responses.

The frequency of the VCO 40 can be varied in either a continuous or a discrete manner by analog or digital means. In one implementation, for example, only two frequency settings are used: a normal setting and a low power setting. The low power setting may be used when, for example, the power related parameter value measured by the power sensor 38 falls below a predetermined threshold. Otherwise, the normal setting may be used. In another approach, a plurality of value bins may be established, with a different frequency assigned to each bin. The VCO may then output a frequency corresponding to a bin within which the measured power related parameter value falls. In at least one embodiment, the power sensor 38 may simply translate an input voltage to a voltage that is appropriate for controlling the VCO 40. The power sensor 38 can also be a signal strength meter or some other sort of sensing device that can determine the overall strength of the interrogation signal. In at least one embodiment, the VCO 40 is a very low power oscillator circuit. Techniques for achieving such low power devices are well known in the art.

In the illustrated embodiment, a tag command processor 42 and tag response state machine 44 are used, at least in part, to generate the response signal to be communicated to the reader. In other embodiments, other techniques for generating the response signal may be used. For example, in one approach, a memory (e.g., an electrically erasable programmable read only memory (EEPROM), etc.) may be present within the tag 30 that includes information (e.g., an ID, an EPC, etc.) of interest to the reader. When the tag 30 is interrogated, the tag 30 may simply retrieve this information from the memory and communicate it to the reader in the response signal. As described above, the frequency of the response signal will depend upon the present value of the transmit clock (i.e., VCO 40). Other techniques for generating the response signal using the adjusted transmit clock may alternatively be used. In at least one embodiment of the present invention, the transmit clock within the tag is permitted to vary continuously (albeit with a finite slew rate) over any portion of the tag's transmission.

When a response signal has been communicated from the tag 30 to the reader, the reader may not know the frequency of the signal beforehand. Instead, timing recovery techniques may be required to determine the frequency or frequencies of the response signal before the signal is demodulated. Techniques for performing timing recovery are well known in the art and will not be discussed further. The use of backscatter antenna impedance modulation within the RFID tag to transmit to the reader usually appears as frequency shift keying (FSK) at the reader device. Thus, FSK based demodulation techniques may be used within the reader in at least one embodiment of the invention.

Some or all of the circuitry of the RFID tag architecture 30 of FIG. 3 may be integrated onto a single (or multiple) semiconductor chip(s). For example, in one implementation, the power sensor 38, the VCO 40, the ASK tag command processor 42, the tag response state machine 44, and the antenna modulation control unit 46 are integrated on a single semiconductor chip. Other combinations of components may alternatively be used. The chip may then be mounted on a substrate or printed circuit board (PCB) that includes the remaining circuitry. The antenna 50 may be printed on the PCB or be coupled thereto. In many cases, the completed tag may be a relatively small, lightweight, and flexible structure.

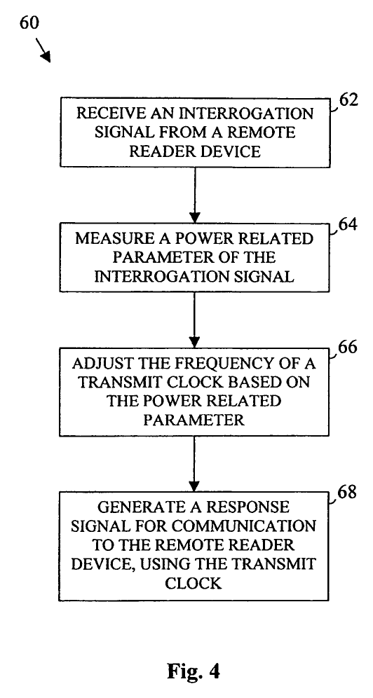

FIG. 4 is a flowchart illustrating an exemplary method 60 for use in operating a passive RFID tag in accordance with an embodiment of the present invention. First, an interrogation signal is received from a remote reader device (block 62). The interrogation signal may be used to provide power to circuitry within the RFID tag. That is, energy from the interrogation signal may be stored within the tag and then used to power the various processing elements of the tag. A power related parameter associated with the interrogation signal is measured (block 64). The frequency of a transmit clock is next adjusted based on the value of the power related parameter (block 66). The adjusted frequency of the transmit clock may be different from the frequency of a corresponding receive clock within the tag. A response signal is then generated for communication to the remote reader device using the transmit clock (block 68). Any technique for generating the response signal may be used, as long as the signal may be demodulated by the reader.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method comprising:
receiving an interrogation signal from a remote reader device;
measuring a power related parameter of said interrogation signal; and
adjusting a frequency of a transmit oscillator based on a measured value of said power related parameter to generate a transmit clock.

2. The method of claim 1, wherein:
said interrogation signal includes amplitude shift keying (ASK) modulation.

3. The method of claim 1, wherein:
measuring a power related parameter of said interrogation signal includes measuring a signal strength of said interrogation signal.

4. The method of claim 1, further comprising:
generating a response signal for communication to the remote reader device using said transmit clock.

5. The method of claim 4, wherein generating a response signal includes:
processing a command portion of said interrogation signal to determine one or more commands of said remote reader device; and
generating a baseband response to said one or more commands using said transmit clock.

6. The method of claim 5, wherein:
generating a response signal includes using backscatter antenna impedance modulation to modulate the impedance of an antenna based on said baseband response.

7. The method of claim 1, wherein:
adjusting a frequency of a transmit oscillator includes setting a higher frequency for a higher value of said power related parameter and a lower frequency for a lower value of said power related parameter.

8. The method of claim 1, wherein:
adjusting a frequency of a transmit oscillator includes applying a voltage to a voltage controlled oscillator.

9. An apparatus for use in an RFID tag, comprising:
a power sensor to measure a power related parameter of a received interrogation signal; and
an adjustable-frequency transmit oscillator to adjust a transmit clock frequency of the RFID tag based on an output of said power sensor.

10. The apparatus of claim 9, further comprising:
a tag command processor to recognize and process one or more commands of said interrogation signal.

11. The apparatus of claim 10, further comprising:
a tag response state machine to generate a tag response based on an output of said tag command processor, said tag response state machine being coupled to receive an output signal from said transmit oscillator.

12. The apparatus of claim 9, further comprising:
an antenna modulation controller to modulate an antenna using backscatter antenna impedance modulation at said transmit clock frequency.

13. The apparatus of claim 9, wherein:
said adjustable-frequency transmit oscillator includes a voltage-controlled oscillator.

14. An RFID tag, comprising:
a dipole antenna to receive an interrogation signal from a wireless channel;
a power sensor to measure a power related parameter of said received interrogation signal; and
an adjustable-frequency transmit oscillator to adjust a transmit clock frequency of the RFID tag based on an output of said power sensor.

15. The RFID tag of claim 14, further comprising:
a tag command processor to recognize and process one or more commands of said interrogation signal.

16. The RFID tag of claim 15, further comprising:
a tag response state machine to generate a tag response based on an output of said tag command processor, said tag response state machine being coupled to receive an output signal from said transmit oscillator.

17. The RFID tag of claim 14, further comprising:
an antenna modulation controller to modulate an antenna using backscatter antenna impedance modulation at said transmit clock frequency.

18. The RFID tag of claim 14, wherein:
said adjustable-frequency transmit oscillator includes a voltage-controlled oscillator.
